(19) United States
(12) Patent Application Publication
(10) Pub. No.: US 2015/0245334 A1
(43) Pub. Date: Aug. 27, 2015

(54) METHOD AND APPARATUS FOR DEVICE TO DEVICE SERVICE IN A WIRELESS COMMUNICATION SYSTEM

(71) Applicant: INNOVATIVE SONIC CORPORATION, Taipei City (TW)

(72) Inventor: Wei-Che Chang, Taipei City (TW)

(21) Appl. No.: 14/627,625

(22) Filed: Feb. 20, 2015

Related U.S. Application Data
(60) Provisional application No. 61/945,468, filed on Feb. 27, 2014.

(51) Int. Cl. H04W 72/04; H04W 76/02

(52) U.S. Cl. CPC H04W 72/0406; H04W 76/023

(57) ABSTRACT

Methods and apparatuses for supporting device to device (D2D) communication are disclosed herein. One method includes monitoring, by a first UE, a scheduling assignment (SA) resource pool. The method also includes transmitting, by the first UE, a first SA in a first SA resource. The method further includes finding, by the first UE, unused SA resources in the SA resource pool. The method also includes transmitting, by the first UE, an extra SA in a second SA resource, wherein the second SA resource is within the unused SA resources.

### CROSS-REFERENCE TO RELATED APPLICATIONS

The present application claims the benefit of U.S. Provisional Patent Application Ser. No. 61/945,468 filed on Feb. 27, 2014 the entire disclosure of which is incorporated herein by reference.

### FIELD

This disclosure generally relates to wireless communication networks, and more particularly, to methods and apparatuses for supporting device to device communication.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

Methods and apparatuses are for improving device to device (D2D) communication are disclosed herein. One method includes monitoring, by a first UE, a scheduling assignment (SA) resource pool. The method also includes transmitting, by the first UE, a first SA in a first SA resource. The method further includes finding, by the first UE, unused SA resources in the SA resource pool. The method also includes transmitting, by the first UE, an extra SA in a second SA resource, wherein the second SA resource is within the unused SA resources.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a flow chart showing D2D broadcast transmitter and receiver procedures.

FIG. 6 is a diagram of different coverage scenarios and transmission resource allocation.

FIG. 7 is a Table listing the steps for a device transmitting data for D2D communication.

FIG. 8 is a Table listing the steps for a device receiving data for D2D communication.

FIG. 9 is a Table listing options for Scheduling Assignment (SA) contents.

FIG. 10 is a flow diagram illustrating one exemplary embodiment.

FIG. 11 is a flow diagram illustrating another exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, or some other modulation techniques.

In particular, the exemplary wireless communication systems devices described below may be designed to support one or more standards such as the standard offered by a consortium named “3rd Generation Partnership Project” referred to herein as 3GPP, including Document Nos. 76 RANI Chairman's Note, R1-140778, “On Scheduling Procedure for D2D,” R2-140623, “D2D Communication Addressing,” and R1-140589, “D2D Communication Resource Scheduling.” The standards and documents listed above are hereby expressly incorporated by reference in their entirety.

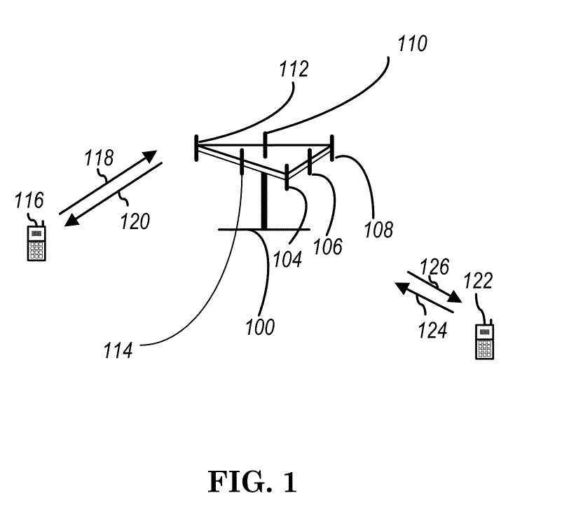

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an eNB, or some other terminology. An access terminal (AT) may also be called user equipment (UE), a wireless communication device, terminal, access terminal or some other terminology.

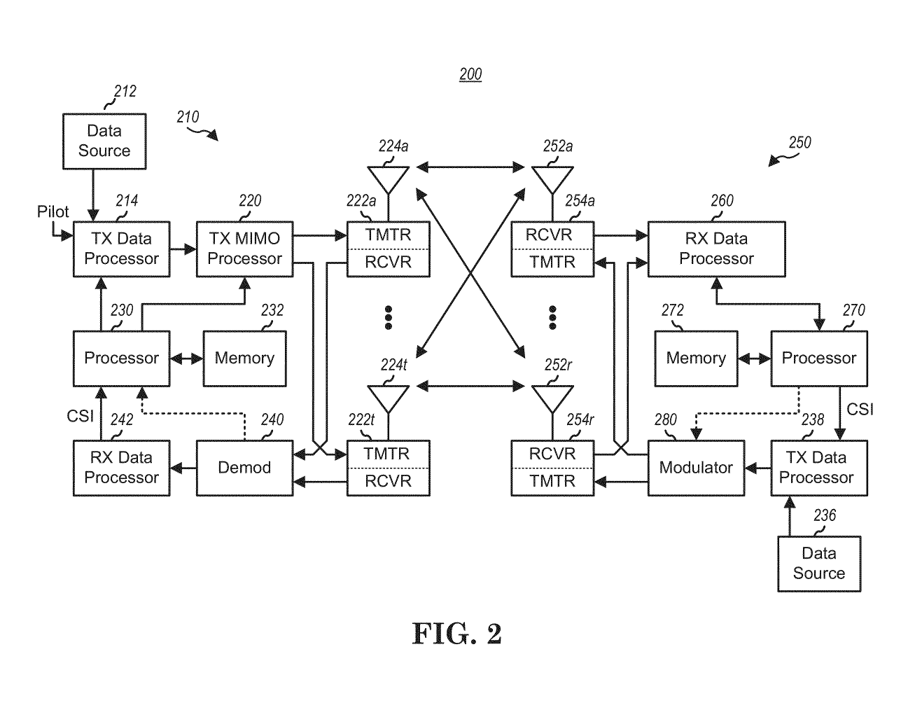

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

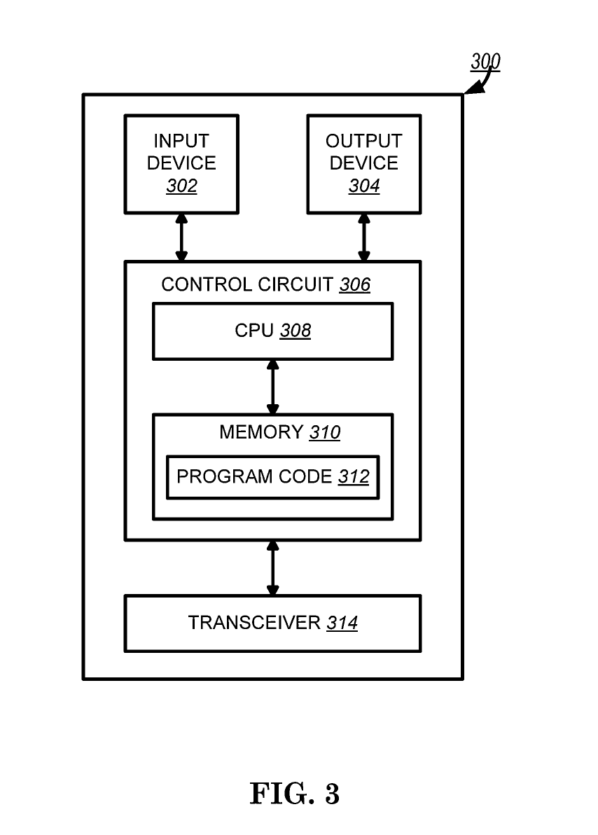

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

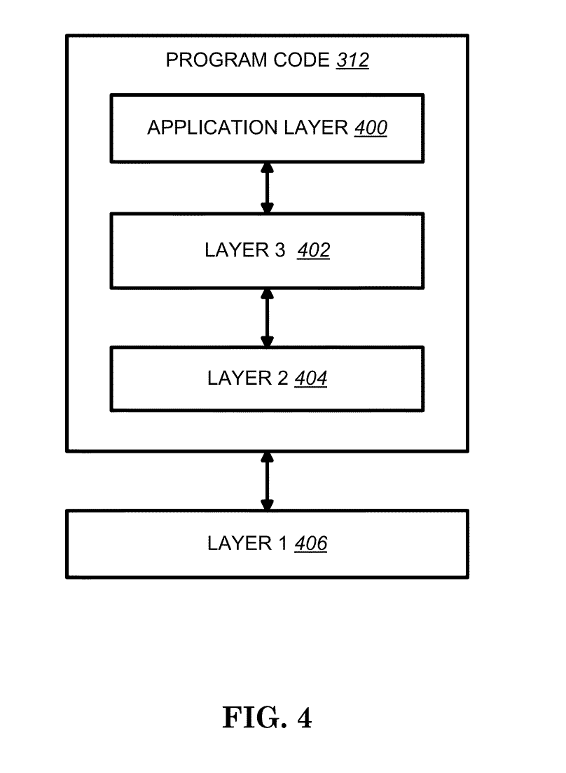

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE or LTE-A systems, the Layer 2 portion may include a Radio Link Control (RLC) layer and a Medium Access Control (MAC) layer. The Layer 3 portion may include a Radio Resource Control (RRC) layer.

In 3GPP #76 RANI meeting minutes, some working assumption about physical channel designing and agreements about resource allocation in D2D communication are quoted below:

### Working Assumption:

For D2D broadcast communication, scheduling assignments that at least indicate the location of the resource(s) for reception of the associated physical channel that carries D2D data are transmitted by the broadcasting UE
   The indication of resource(s) for reception may be implicit and/or explicit based on scheduling assignment resource or content
Scheduling assignments use PUSCH structure for transmission
   Details of PUSCH structure including DMRS and RE mapping are FFS
   At least the following are not precluded from further study: Scheduling assignments piggybacked with data, or indicated over DMRS
For Mode 2
   A resource pool for scheduling assignment is pre-configured and/or semi-statically allocated
      FFS whether the resource pool for scheduling assignment is same as the resource pool for D2D data
   UE on its own selects the resource for scheduling assignment from the resource pool for scheduling assignment to transmit its scheduling assignment
For Mode 1
   the location of the resources for transmission of the scheduling assignment by the broadcasting UE comes from the eNodeB
   the location of the resource(s) for transmission of the D2D data by the broadcasting UE comes from the eNodeB
      Discuss the following further offline:
Additional Proposal for Mode 1
   A resource pool for scheduling assignment is semi-statically allocated
      If there is a resource pool allocated for D2D data it is FFS whether the resource pool for scheduling assignment is same as the resource pool for D2D data

Agreements:
From a transmitting UE perspective a UE can operate in two modes for resource allocation:
   Mode 1: eNodeB or rel-10 relay node schedules the exact resources used by a UE to transmit direct data and direct control information
      FFS: if semi-static resource pool restricting the available resources for data and/or control is needed
   Mode 2: a UE on its own selects resources from resource pools to transmit direct data and direct control information
      FFS if the resource pools for data and control are the same
      FFS: if semi-static and/or pre-configured resource pool restricting the available resources for data and/or control is needed
   D2D communication capable UE shall support at least Mode 1 for in-coverage
   D2D communication capable UE shall support Mode 2 for at least edge-of-coverage and/or out-of-coverage
   FFS: Definition of out-of-coverage, edge-of-coverage, in-coverage

Agreement:
For example, definition of coverage areas is at least based on DL received power

Possible Agreements:
D2D communication capable UE shall support both Mode 1 and Mode 2
   FFS: Mode 2 for in-coverage and Mode 1 for edge-of-coverage, out-of-coverage
For in-coverage, it is up to operator to allow Mode 1 and/or Mode 2
   FFS: Mode 2 for in-coverage and Mode 1 for edge-of-coverage, out-of-coverage
FFS how to configure between Mode 1 and Mode 2, e.g., whether there is a condition to configure switching between Mode 1 and Mode 2

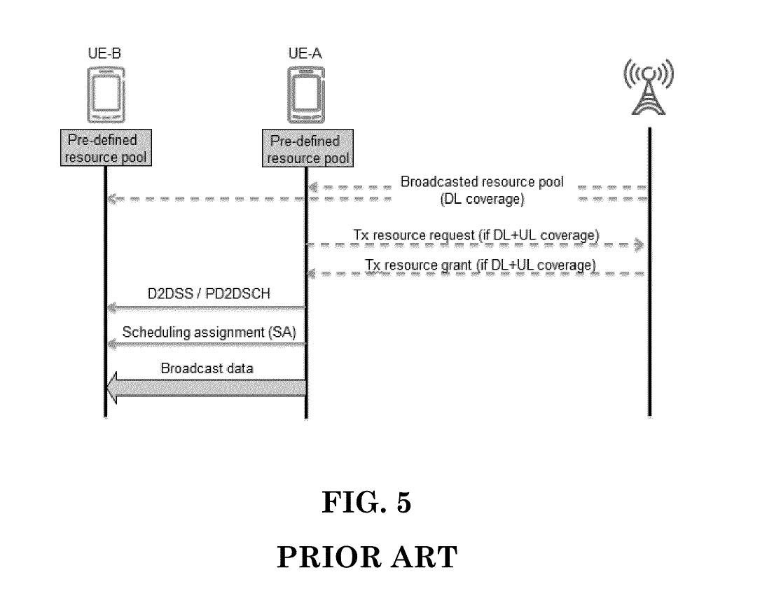

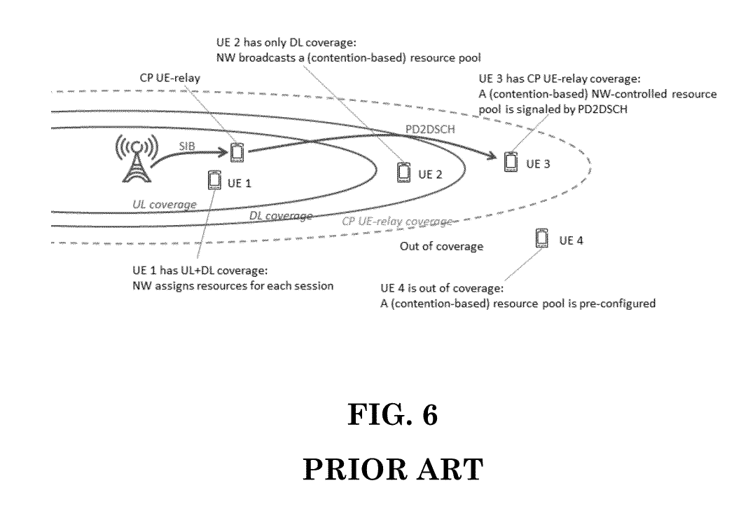

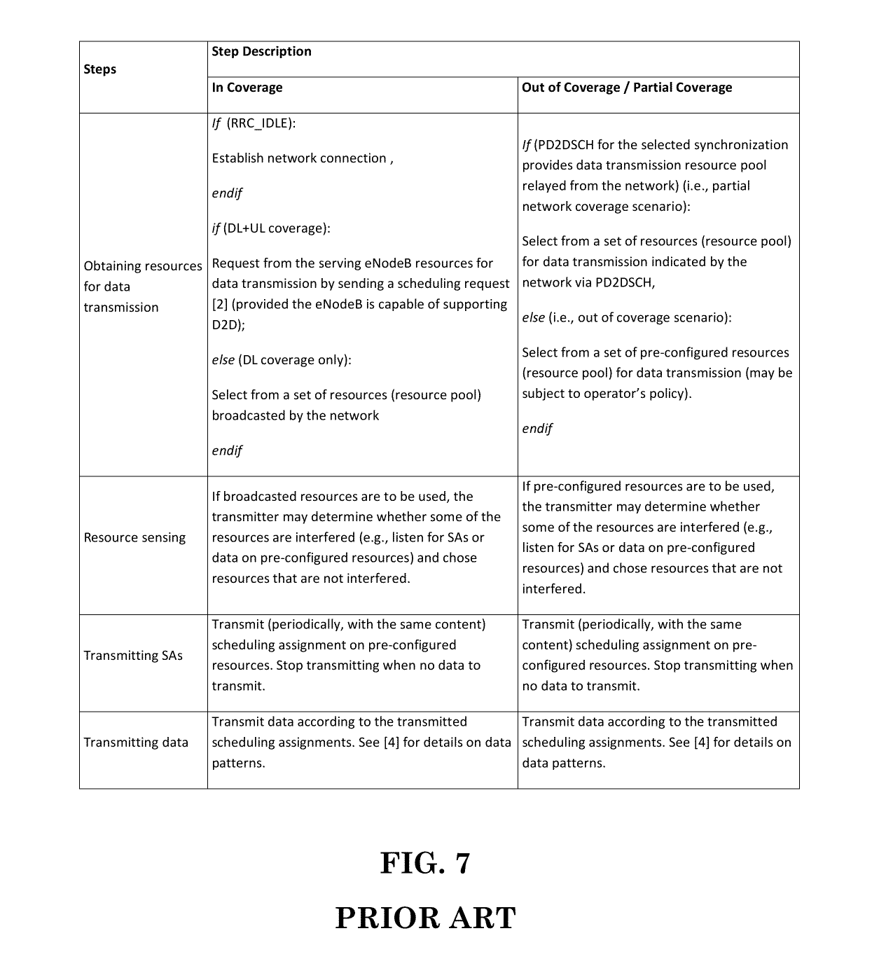

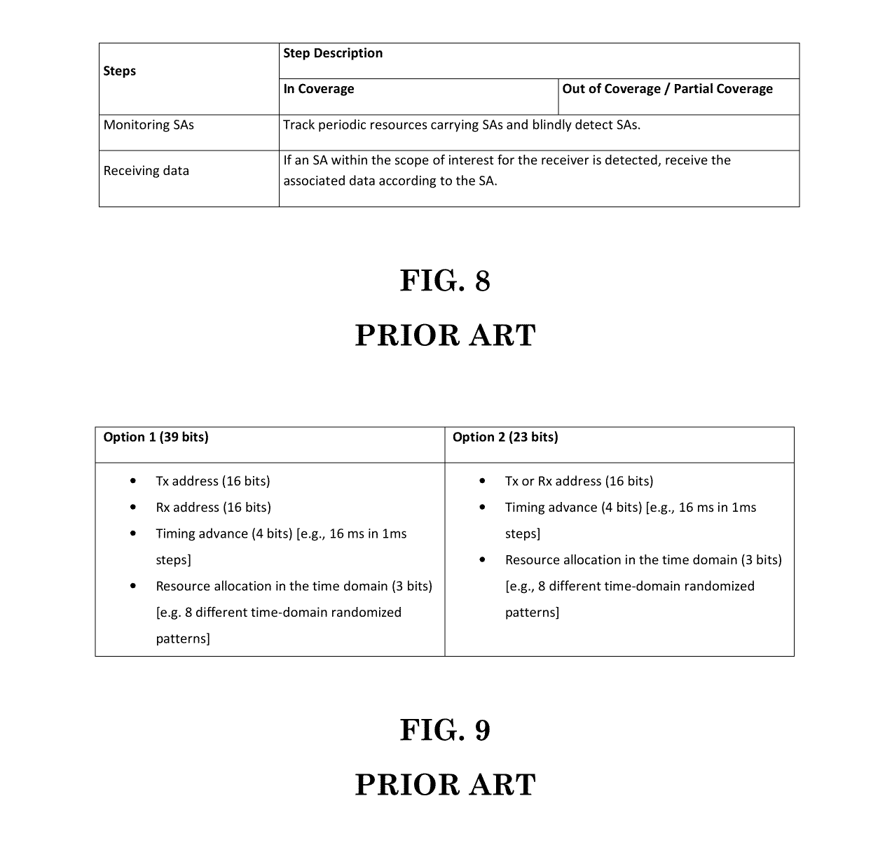

The following is the possible scheduling procedure in D2D communication from RANI R1-140778. In this document, it mentions possible D2D communication flow and basic function and contents of scheduling assignment (SA).
2. Scheduling Procedure
The scheduling procedure for D2D communication involves the following two major phases:
obtaining resources for transmissions/receptions, and
transmission/reception for a D2D transmitter/receiver, respectively, where the transmissions consist of scheduling assignment (SA) transmissions and the actual data transmissions.
FIG. 5 illustrates the scheduling procedure, the details of which are further described below.
Naturally, there are some differences in the procedure for in-coverage and out-of-coverage D2D transmitters, since under the network coverage the possibility to exploit the network control is vital to ensure that none of the cellular performance and D2D performance is degraded when D2D operation is enabled in the cellular network. FIG. 6 illustrates different coverage scenarios.
FIG. 7 summarizes the scheduling procedure for D2D for a device transmitting data. One should also note that a D2D UE is also performing transmitter synchronization which is needed for D2D communication, among the others. When the UE is synchronized to an internal or external synchronization source, the UE can transmit D2DSS/PD2DSCH. For the transmitter synchronization,
when under network coverage, the UE synchronizes to the serving/camping eNodeB;
when out of network coverage, the UE synchronizes to the single most suitable UE-transmitted D2DSS/PD2DSCH; if no suitable D2DSS/PD2DSCH is found, the UE adopts internal synchronization source
FIG. 8 summarizes the scheduling procedure for D2D for a device receiving data. Prior to the steps described in the table, for both the in-coverage and out-of-coverage scenarios, the D2D receiver needs to synchronize its receiver to a synchronization reference as disclosed in [1].
3. Scheduling Assignments (SAs)
An SA is a compact (low-payload) message containing control information, e.g., pointer(s) to time-frequency resources for the corresponding data transmissions. The contents of SAs (i.e., the actual data scheduling) may be decided autonomously by the broadcasting node (e.g., when out-of-coverage) or by the network (e.g., when in coverage or in partial coverage). Each SA carries also an L1 SA identity [5] to allow the receiving UE to only decode the data that is relevant for this UE. Example contents of an SA are provided in FIG. 9, where Option 1 and Option 2 are shown (see [4] for simulation results for the two options; see [5] for more details on the two options).

Following from the RANI #76 meeting minutes, the UE is capable of D2D communication should operate in two modes of resource allocation. In Mode 1 communication, the UE transmit the resource request to the eNB and receive the resource grant from eNB to achieve the D2D communication. Since the resources for D2D communication are indicated and controlled by eNB or Relay in Mode 1, there would not have any resources collision problem. However, in Mode 2 communication, the UE on its own to select resources from resource pool to transmit D2D data. In the scenario which UE cannot request resources from eNB, possible ways to select resources from resource pool are random selection and monitoring-based selection. Compare with monitoring-based resource selection, random resources selection is more simple way to choose the data resources. However, the resource collision probability is also much higher than monitoring-based way.

In monitoring-based resources allocation, all of the transmitting UEs monitor the resource pool for some period and find some useful resources to transmit D2D data. Afterwards, the transmitting UEs adopt the unused resources (or based on some resource selection criteria) to transmit D2D data. However, the receiving UE receives all of the possible data resource and decode the D2D data which may cause large UE power consumption. In order to solve the power consumption issue, the scheduling assignment (SA) is proposed to indicate the specific UE to receive the specific data resources.

A scheduling assignment (SA) includes at least indication of the resources in the data resource pool for specific UE to receive. The transmitting UE transmits the SA in the SA resource pool. The transmitting UE also broadcasts the SA to indicate the specific UE to receive and decode the specific data resources. Moreover, the SA resource pool may be separated from the data resource pool to simplify the design of the D2D resource allocation. In case of a UE on the cell edge scenario, the transmitting UE would only receive the DL broadcast signal which includes the resource pool information. After the UE monitors the SA resource pool, the transmitting UE transmits a SA in the SA resources. In the cell edge scenario, after the transmitting UE transmits the first SA, how to deal with the unused SA resource in the SA resource pool has not been discuss nor disclosed. Moreover, if a transmitting UE transmits extra SAs, the raised collision probability of the extra SA and the new SA from new participated transmitting UE is also need to be solved.

In case of cell edge scenario, the transmitting UE only receives the DL broadcast signal which includes the resource pool information. After transmitting UE monitoring the SA resource pool, the UE transmits a SA in SA resources to indicate a specific UE to receive and decode the specific data resources. However, after the UE monitors the next SA period, the UE may find that there are some unused SA resources in the SA resource pool. In one embodiment, the unused SA resources are utilized to allow heavy data loading UEs to transmit extra SA.

In the event that UEs transmit extra SAs, the collision probability due to extra SAs and new SAs from new participated transmitting UE may increase. In one embodiment, a possible solution to solve the collision is to have the transmitting UE alternative between transmitting the extra SA and monitoring the corresponding SA resources. For example, in one embodiment, in the first period, the UE transmits the first SA and extra SAs. In the second period, the UE releases the extra SAs and monitors the second SA period to finds any new unused SA resources. In third period, the transmitting UE transmits the first SA and any new extra SAs during the third SA period.

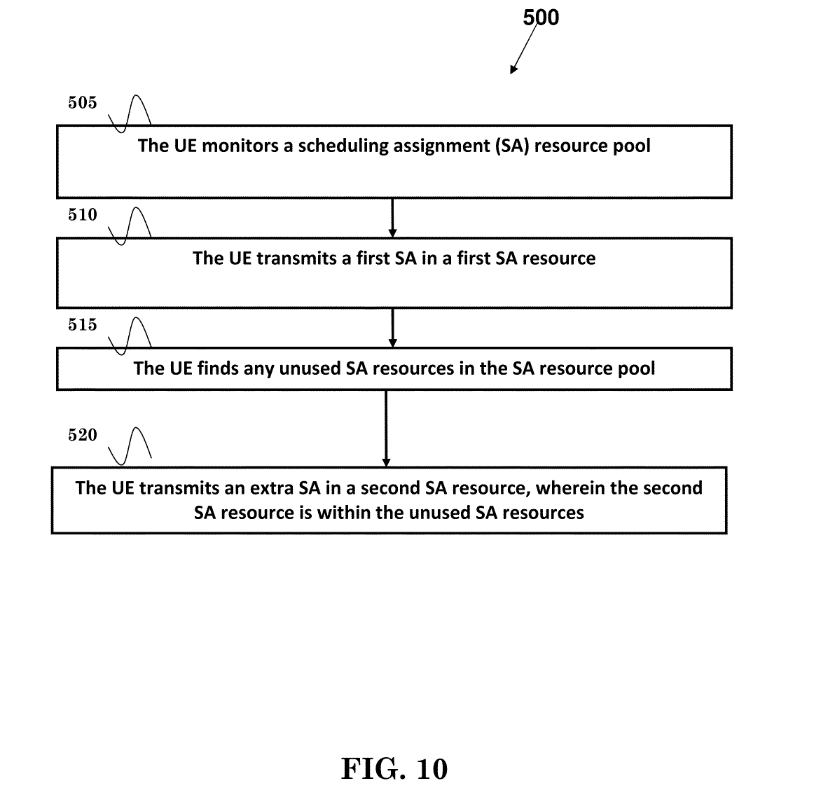

FIG. 10 illustrates one exemplary method 500 for supporting device to device (D2D) communication, wherein a user equipment (UE) is capable of D2D communication. At step 505, the UE monitors a scheduling assignment (SA) resource pool. At step 510, the UE transmits a first SA in a first SA resource. At step 515, the UE finds any unused SA resources in the SA resource pool. At step 520, the UE transmits an extra SA in a second SA resource, wherein the second SA resource is within the unused SA resources. The UE may be a first UE.

In another embodiment, a criterion for the first UE to transmit the extra SA is based on data in a buffer associated with the D2D communication. In another embodiment, the first SA resource is different than the second SA resource.

In yet another embodiment, the content of the first SA includes an address of a transmitting and receiving UE. In another embodiment, the content of the extra SA includes an address of a transmitting and receiving UE.

In one embodiment, the address of transmitting and receiving UE of the extra SA is same as the address of the transmitting and receiving UE of first SA.

In one embodiment, the content of first SA contains corresponding data resource indications to indicate the corresponding data resource locations in the data resource pool. In another embodiment, the content of the extra SA contains corresponding data resource indications to indicate the corresponding data resource locations in the data resource pool.

In yet another embodiment, the first UE cannot directly request D2D resources from an evolved Node B (eNB). In one embodiment, the SA resource pool is different than a data resource pool. In another embodiment, the SA resource pool and the data resource pool are preconfigured. In yet another embodiment, the SA resource pool and the data resource pool are semi-static.

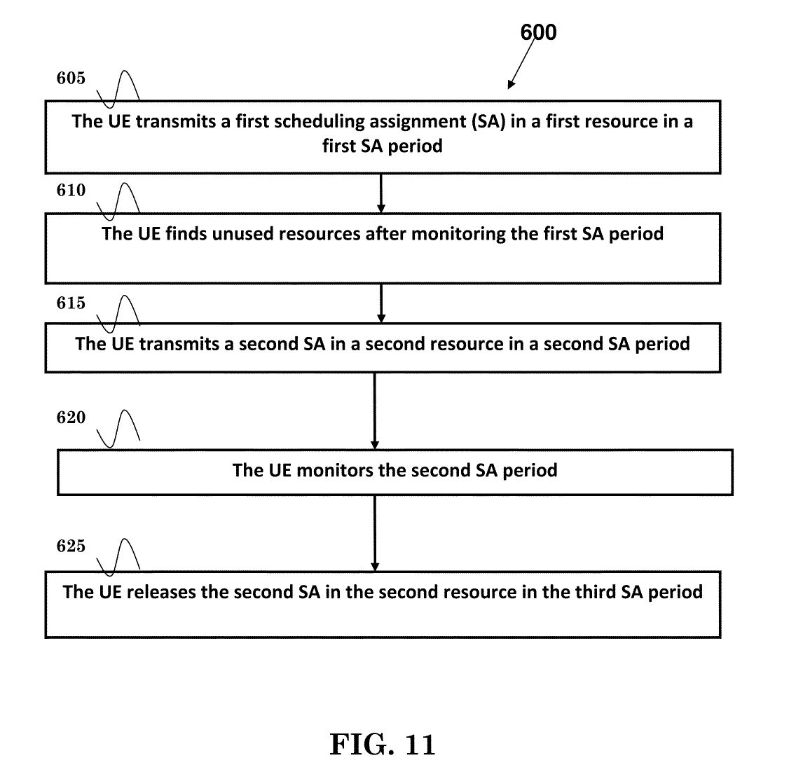

FIG. 11 illustrates one exemplary method 600 for supporting device to device (D2D) communication, wherein a user equipment (UE) is capable of D2D communication. At step 605, the UE transmits a first scheduling assignment (SA) in a first resource in a first SA period. At step 610, the UE finds unused resources after monitoring the first SA period. At step 615, the UE transmits a second SA in a second resource in a second SA period. At step 620, the UE monitors the second SA period. At step 625, the UE releases the second SA in the second resource in the third SA period. The UE may be a first UE.

In another exemplary method, the first UE monitors the third SA period. The first UE finds any unused SA resources. The first UE then transmits one or more SAs in a fourth SA period after the first UE finds unused resources.

In another embodiment, the first SA resource is different than the second SA resource. In one embodiment, the first, second, and third SA periods are periods of a SA resource pool. In another embodiment, the first UE cannot directly request D2D resources from an evolved Node B (eNB). In yet another embodiment, resources of the D2D communication are selected from a resource pool.

Referring back to FIGS. 3 and 4, the device 300 includes a program code 312 stored in memory 310 for supporting device to device (D2D) communication, wherein a user equipment (UE) is capable of D2D communication. In one embodiment, the CPU 308 could execute program code 312 to enable the UE (i) to monitor a scheduling assignment (SA) resource pool, (ii) to transmit a first SA in a first SA resource, (iii) to find any unused SA resources in the SA resource pool, and (iv) to transmit an extra SA in a second SA resource, wherein the second SA resource is within the unused SA resources. In addition, the CPU 308 can execute the program code 312 to perform all of the above-described actions and steps or others described herein.

Alternatively, the device 300 include a program code 312 stored in memory 310 for supporting device to device (D2D) communication, wherein a user equipment (UE) is capable of D2D communication. In one embodiment, the CPU 308 could execute program code 312 to enable the UE (i) to transmits a first scheduling assignment (SA) in a first resource in a first SA period, (ii) to find unused resources after monitoring the first SA period, (iii) to transmit a second SA in a second resource in a second SA period, (iv) to monitor the second SA period, and (v) to release the second SA in the second resource in the third SA period. In addition, the CPU 308 can execute the program code 312 to perform all of the above-described actions and steps or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for supporting device to device (D2D) communication, wherein a user equipment (UE) is capable of D2D communication, the method comprising:
monitoring, by a first UE, a scheduling assignment (SA) resource pool;
transmitting, by the first UE, a first SA in a first SA resource;
finding, by the first UE, unused SA resources in the SA resource pool; and
transmitting, by the first UE, an extra SA in a second SA resource, wherein the second SA resource is within the unused SA resources.

2. The method of claim 1, wherein a criterion for the first UE to transmit the extra SA is based on data in a buffer associated with the D2D communication.

3. The method of claim 1, wherein the first SA resource is different than the second SA resource.

4. The method of claim 1, wherein the content of the first SA includes an address of a transmitting and receiving UE.

5. The method of claim 4, wherein the content of the extra SA includes an address of a transmitting and receiving UE.

6. The method of claim 5, wherein the address of transmitting and receiving UE of the extra SA is same as the address of the transmitting and receiving UE of first SA.

7. The method of claim 1, wherein the content of first SA contains corresponding data resource indications to indicate the corresponding data resource locations in the data resource pool.

8. The method of claim 1, wherein the content of the extra SA contains corresponding data resource indications to indicate the corresponding data resource locations in the data resource pool.

9. The method of claim 1, wherein the first UE cannot directly request D2D resources from an evolved Node B (eNB).

10. The method of claim 1, wherein the SA resource pool is different than a data resource pool.

11. The method of claim 1, wherein the SA resource pool and the data resource pool are preconfigured.

12. The method of claim 1, wherein the SA resource pool and the data resource pool are semi-static.

13. A method for supporting device to device (D2D) communication, wherein a user equipment (UE) is capable of D2D communication, the method comprising:
transmitting, by a first UE, a first scheduling assignment (SA) in a first resource in a first SA period;
finding, by the first UE, unused resources after monitoring the first SA period;
transmitting, by the first UE, a second SA in a second resource in a second SA period;
monitoring, by the first UE, the second SA period; and
releasing, by the first UE, the second SA in the second resource in a third SA period.

14. The method of claim 13, wherein the first SA resource is different than the second SA resource.

15. The method of claim 13, wherein the first, second, and third SA periods are periods of a SA resource pool.

16. The method of claim 13, wherein the first UE cannot directly request D2D resources from an evolved Node B (eNB).

17. The method of claim 13, further comprising:
monitoring, by the first UE, the third SA period;
finding, by the first UE, unused SA resources; and
transmitting, by the first UE, one or more SAs in a fourth SA period after the first UE finds unused resources.

18. The method of claim 13, wherein resources of the D2D communication are selected from a resource pool.

19. A communication device for improving device to device (D2D) communication, the communication device comprising:
a control circuit;
a processor installed in the control circuit;
a memory installed in the control circuit and operatively coupled to the processor;
wherein the processor is configured to execute a program code stored in memory to enable the UE to:
monitor a scheduling assignment (SA) resource pool;
transmit a first SA in a first SA resource;
find unused SA resources in the SA resource pool; and
transmit an extra SA in a second SA resource, wherein the second SA resource is within the unused SA resources.

20. The communication device of claim 19, wherein a criterion for the first UE to transmit the extra SA is based on data in a buffer associated with the D2D communication.
